(19) United States
(12) Patent Application Publication
(10) Pub. No.: US 2003/0041499 A1
(43) Pub. Date: Mar. 6, 2003

(54) Hunting dummy and method for preparing area of hunting

(76) Inventors: Steven Lloyd Jarvis, Como, TX (US); Lynn Celeste Jarvis, Como, TX (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/883,374

(22) Filed: Jun. 19, 2001

(51) Int. Cl. A01M 1/00

(52) U.S. Cl. 43/1

(57) ABSTRACT

A method for preparing an area for hunting or wildlife observation, comprising providing a dummy bearing an image of at least an upper torso of a person in the area for a period of time prior to the time of the hunt or wildlife observation.

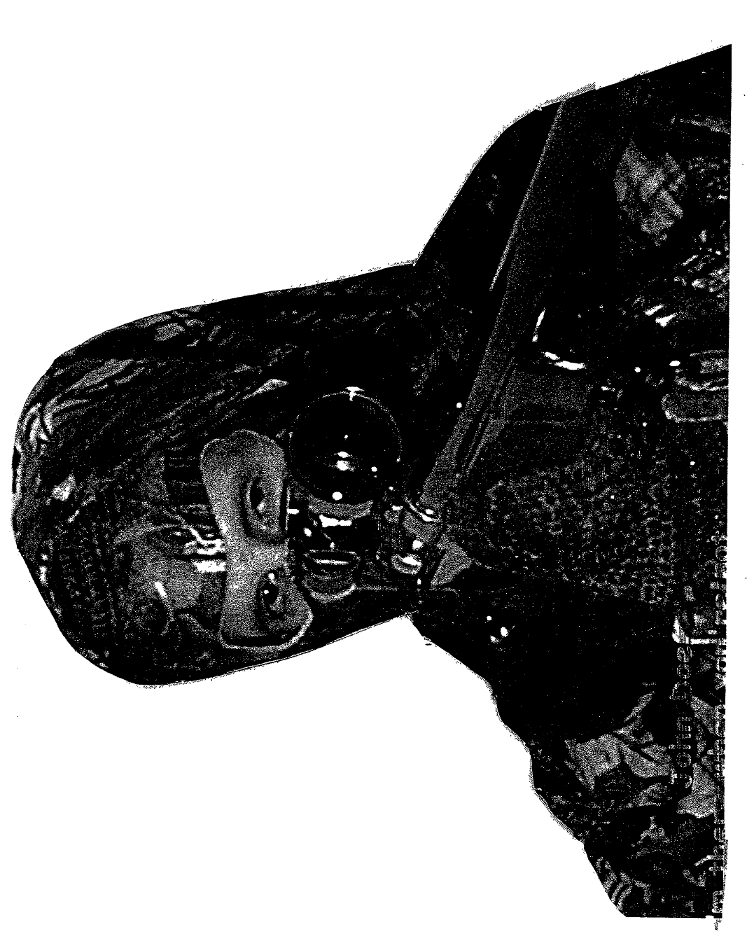

### BACKGROUND OF THE INVENTION

Hunters of game and observers of wildlife generally attempt to conceal themselves when hunting and observing. One common practice is to construct a sealing enclosure, commonly called a hunting blind, from which one may hunt game or observe wildlife. One problem typically encountered with attempting to conceal oneself, in general, and with hunting blinds in particular, is that it is difficult, if not impossible, to completely conceal oneself. When an animal is able to see a hunter or observer in an area in which humans are not normally found, the animal will tend not to enter that area. Thus, despite the attempts at concealment, e.g., in hunting blinds, animals may spot the person and avoid the hunting area.

### SUMMARY OF THE INVENTION

The present invention solves the aforementioned problems by providing a dummy resembling a hunter or observer. The dummy can resemble the full height of a person or a part thereof, e.g., from the chest up. The dummy is preferably approximately life size and may either be in the exact shape of the hunter or in any other shape, e.g., round, oval, square or rectangular with an image of the hunter thereon. An area is prepared for hunting or observing, according to the present invention, by providing such a dummy in the area in the time prior to the hunt or wildlife observation.

### BRIEF DESCRIPTION OF THE DRAWING

The attached FIGURE represents one embodiment of the dummy according to the present invention.

### DETAILED DESCRIPTION

One embodiment of the dummy of the present invention is shown in the attached FIGURE. In the embodiment shown, the dummy is a life-size two-dimensional image of a hunter from the chest up. In the embodiment shown, the dummy takes the shape, in two dimensions, of the hunter. The image can be applied to any material, but preferably as applied to a flexible material, e.g., a material from which computer mouse pads are typically made.

The image may be of a hunter as shown in the FIGURE, or just of a person without hunting equipment. While making the dummy of an image of a person from the chest up is preferable, it is of course possible to provide a dummy having the image of the entire person. As shown in the preferred embodiment, the dummy is preferably cut to the shape of the image, but it is also possible to provide a dummy having a round, oval, square, rectangular or other shape having the image of the person thereon.

The area can be prepared for hunting or wildlife observation by placing the dummy in a location, e.g., in a hunting blind, prior to the time of hunting or wildlife observation. By impersonating a hunter or wildlife observer, animals will be fooled into thinking that there is a human in the area and become used to the sight of the human. Animals will be less cautious to enter into the hunting or observation area.

If the dummy is made from a flexible material, it can be also used as a seat or back cushion while hunting or as a gun rest.

It is also possible to make a three-dimensional dummy.

We claim

1. A method for preparing an area for hunting or wildlife observation, comprising providing a dummy bearing an image of at least an upper torso of a person in the area for a period of time prior to the time of the hunt or wildlife observation.
